(19) United States
(12) Patent Application Publication
(10) Pub. No.: US 2007/0262113 A1
(43) Pub. Date: Nov. 15, 2007

(54) Sling-Roll Bag

(75) Inventor: Adam Dickinson, Staffordshire (GB)

Correspondence Address: BARNES & THORNBURG LLP, 11 SOUTH MERIDIAN, INDIANAPOLIS, IN, 46204, US

(73) Assignee: EPS FZC, Sharjah (AE)

(21) Appl. No.: 10/596,061

(22) PCT Filed: Nov. 29, 2004
(86) PCT No.: PCT/GB04/04991

§ 371 Date: Mar. 28, 2007

(30) Foreign Application Priority Data
Nov. 28, 2003 (GB) 0327653.2

(51) Int. Cl. B26F 3/02

(52) U.S. Cl. 225/96; 29/412; 383/37

(57) ABSTRACT

A bag dispenser having a sling for supporting a roll of pre-formed bags.

The invention relates to plastic bag dispensers and in particular to preformed bags supplied in a roll.

Bags of the kind described are used frequently in shops and supermarkets for retaining loose grocery items, for example fruit and vegetables. Typically, the dispenser will retain a roll of bags with perforations therebetween allowing the user to remove one bag at a time from the dispenser. The removal of the bag will facilitate the opening of the mouth of the bag.

However, there are problems associated with this form of bag dispenser. In particular, the dispenser will frequently deliver more than one bag to the user creating unnecessary expense for the shop proprietor. Furthermore, it may be that the bag can be removed from the dispenser without the mouth of the bag having been opened.

It is an object of the invention to provide an improved bag dispenser and roll of bags therefor.

According to the first aspect of the invention there is provided a bag dispenser having a sling for supporting a roll of pre-formed bags.

Preferably, the sling is defined by a sheet of flexible sheet material, supported at either end by two support members.

Alternatively, the sling may be defined by a sheet of flexible sheet material, supported by a single support member.

The flexible nature of the sheet material which forms the sling allows the sling to make contact with as much of the circumferential profile of the roll as possible thereby maximising the friction generated between the roll and the sling. This friction provides a reaction against the force of removing a bag from the roll, as will be described further below.

Advantageously, this arrangement provides the consumer with a repeatable delivery of single, open bags and minimises the cost of wasted bags realised by the proprietor of a shop using the dispenser. This is achieved by minimising the likelihood of more than one bag being delivered to the consumer at a time.

In a preferred form of the alternative embodiment of the sling, the sling has a slit which allows passage of a pre-formed bag from a roll of pre-formed bags.

Preferably, the sling is retained by a first support member at a first end and a second support member at a second end, the first and second support members being in fixed relation.

In a further alternative embodiment the first and second support members are in substantially the same horizontal plane.

In a preferred form of the further alternative embodiment a sling tension member is provided so as to form a neck in the profile of the sling.

Preferably, the second support member is arranged such that in use it is vertically above and horizontally displaced from the first support member.

Advantageously this sling arrangement allows the position of the bag in the sling to be optimised as the roll reduces in diameter by virtue of removal of bags therefrom.

Preferably, the sling has a length of between 175% and 225% of the distance between the first support member and the second support member, most preferably 200%.

Preferably, the dispenser includes a separator which in use facilitates the separation of a bag from the roll of preformed bags.

Preferably, the separator has a tip arranged in proximity to and substantially in the same horizontal plane as the first support member.

Advantageously, this arrangement of separator improves the repeatability of the user removing a single bag from the roll of bags which reduces the number of wasted bags. Furthermore, this feature of the invention also facilitates the opening of the mouth of the bag on removal of the bag from the roll.

Preferably, the separator is arranged in line with a midpoint of the support member.

Preferably, the first support member is arranged between the separator and the second support member.

Preferably the sling is formed from a mesh material, preferably a plastic coated fibreglass mesh material.

Advantageously, this feature of the invention generates a level of friction between the sling and the roll of bags which provides a level of resistance against which the user acts in removing a bag from the roll of bags by use of the separator.

Preferably the tip of the separator is coated in a high-friction material, most preferably a plastic coated fibreglass mesh material.

Advantageously, this feature of the invention generates friction between the bag being removed from the roll of bags and the separator further improving the repeatability of removing a single, open bag from the roll of bags.

According to a second aspect of the present invention there is provided a roll of pre-formed bags, the roll being formed from a flat folded tube, each pre-formed bag having a longitudinally arranged central portion and two longitudinally arranged exterior portions, one arranged on either side of the central portion, the central portion being of two ply cross-section and each of the exterior portions being of an at least 4 ply cross-section.

Advantageously, this arrangement of roll provides a central portion of limited thickness, ie only 2 ply, for interaction with the separator. Since the separator has only a 2 ply thickness of plastics material to penetrate, this arrangement of roll offers improved repeatability of single bag removal.

Preferably, the exterior portions have an 8 ply cross-section.

Preferably, the central portion defines a transversely arranged central slit, each of the exterior portions defining a transversely arranged perforation which is substantially in line with the central slit.

Preferably the pre-formed bag has a base seal arranged in close proximity to the central slit.

Advantageously, this feature minimises the wasted plastics material between the base of one bag and the mouth opening of the next bag.

Preferably, the base seal runs substantially parallel to the central slit and perforations.

Preferably, the roll of pre-formed bags includes a cylindrical core of substantially the same width as the preformed bag.

In prior art rolls the core has typically protruded beyond the outer profile of the rolled bags in order to allow for the mounting of the core to a prior art dispenser. This form of protruding core is no longer necessary in the present invention since the core is not used to mount the roll of bags to the dispenser.

Advantageously, this arrangement of cylindrical base reduces the quantity of plastics material required to manufacture the base and thereby reduces the cost of manufacture of the roll of pre-formed bags.

According to a third aspect of the invention there is provided a method of making a roll of bags including the steps of
forming a continuous tube from a plastics material,
folding the tube so as to form two longitudinally arranged gusset portions,
folding each gusset portion so as to form a longitudinally arranged central portion and two longitudinally arranged exterior portions, one arranged on either side of the central portion, the central portion being of two ply cross-section and each of the exterior portions being of an at least 8 ply cross-section,
further including the steps of transversely sealing the continuous tube at a predetermined interval so as to form a base seal,
transversely perforating the exterior portions in close proximity to the base seal,
forming a slit in the central portion which is substantially collinear with the perforations, and
rolling the continuous tube into a roll of bags.

The invention will now be described by way of non-limiting example with reference to the accompanying drawings, in which:

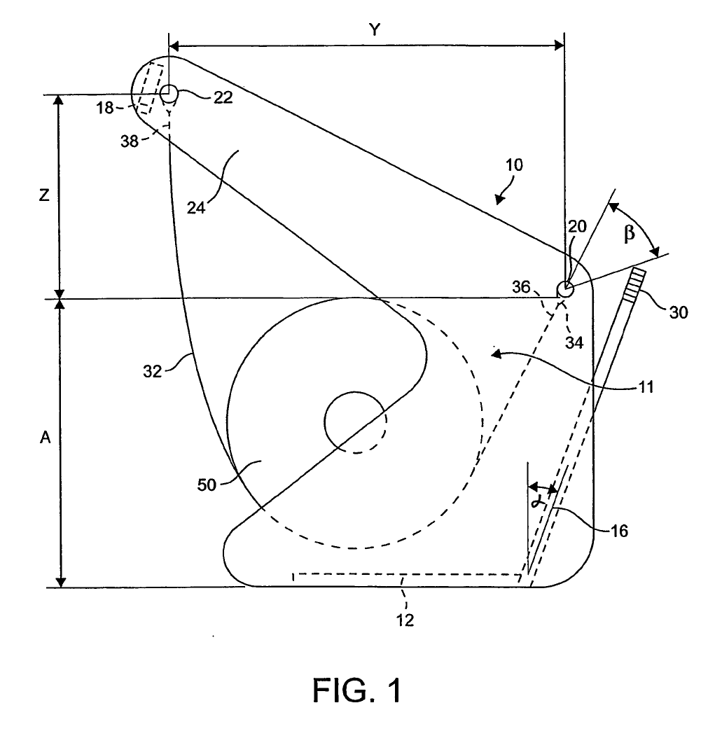

FIG. 1 is a side view of a first embodiment of the dispenser and roll of bags according to the present invention showing hidden detail, and

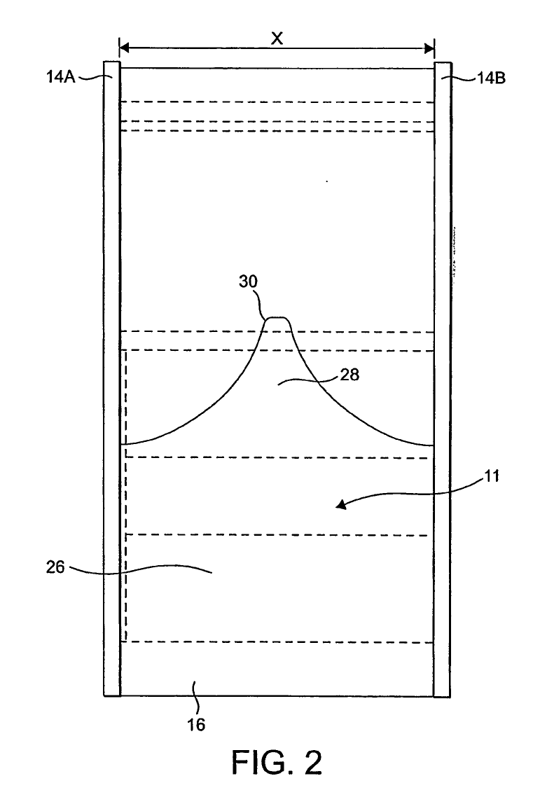

FIG. 2 is an end view of the dispenser and roll of bags of FIG. 1 showing hidden detail.

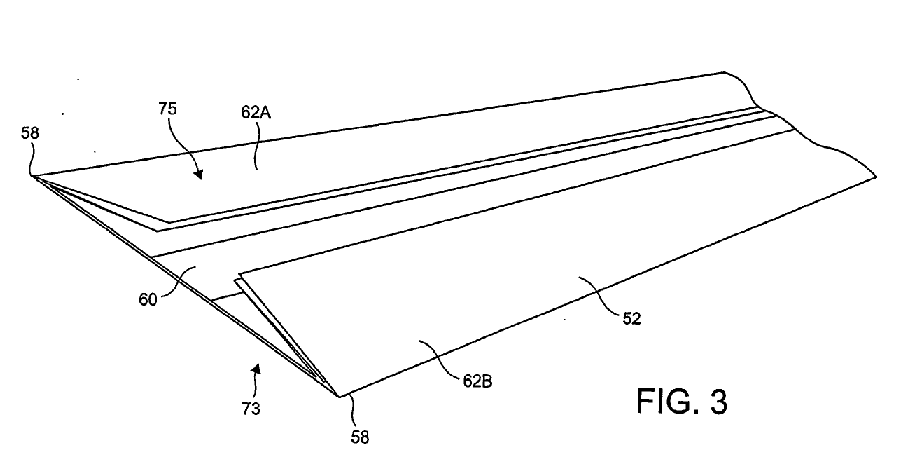

FIG. 3 is a perspective part view of an end of the roll of bags of FIG. 1,

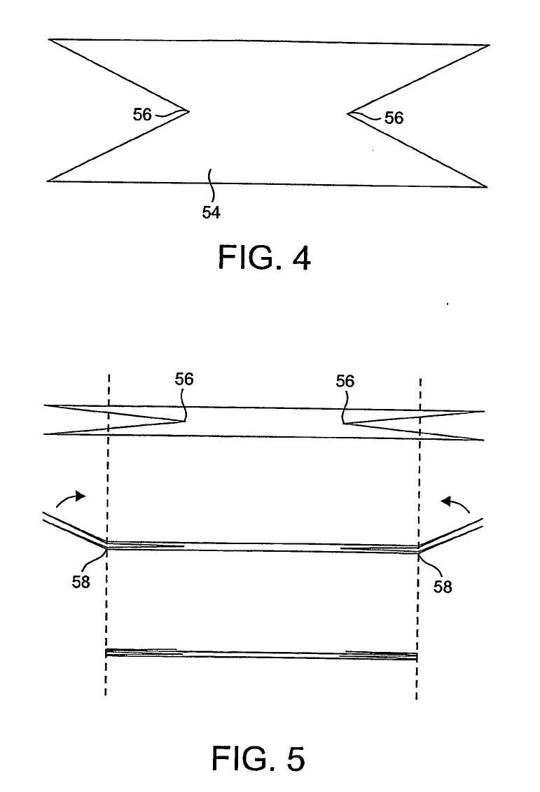

FIG. 4 is a cross-section view of the roll of bags of FIG. 1 in a first stage of production,

FIG. 5 is a cross-section view of the roll of bags of FIG. 1 in a second stage of production,

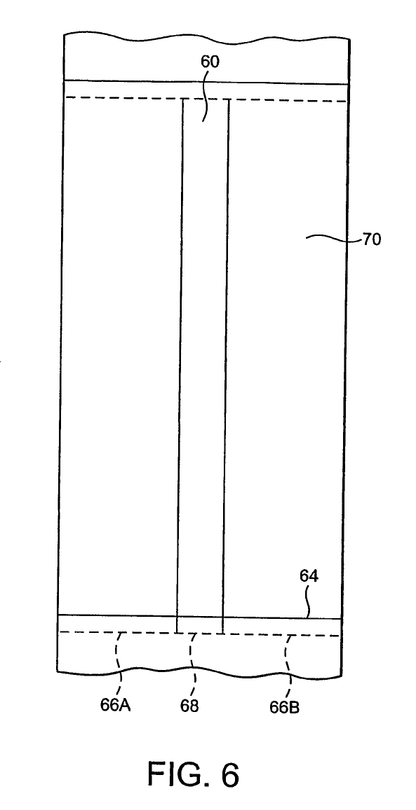

FIG. 6 is a plan view of a bag forming part of the roll of bags of FIG. 1,

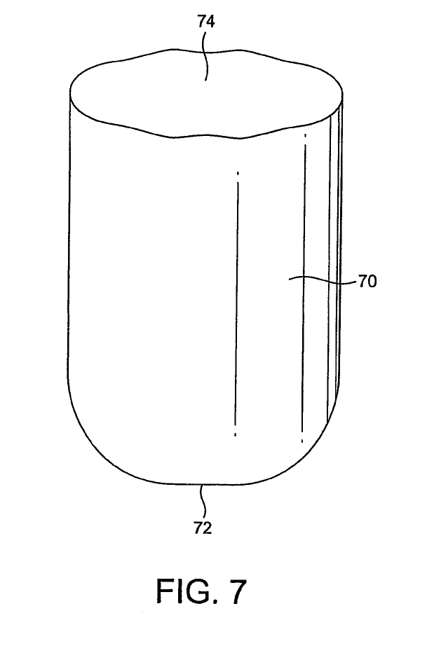

FIG. 7 is a perspective view of the bag of FIG. 6 shown in its opened state,

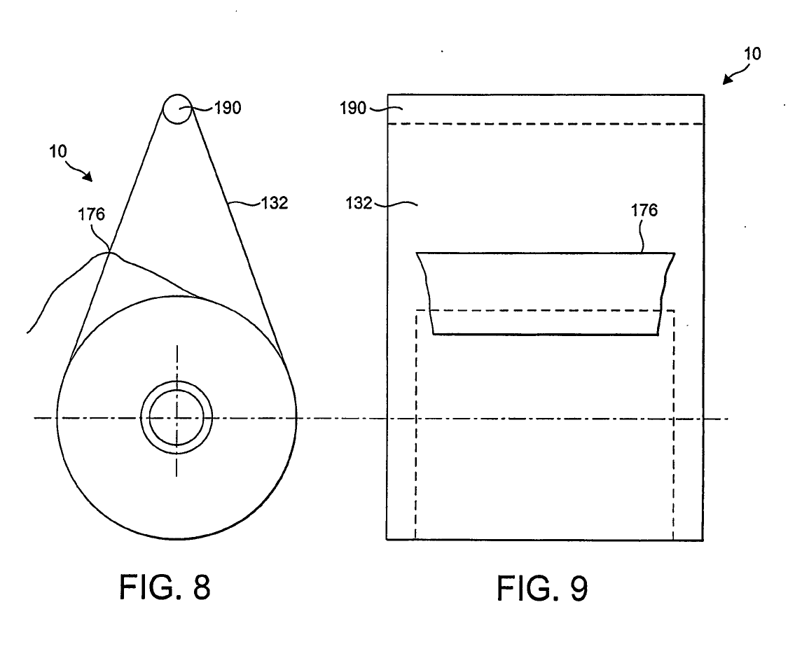

FIG. 8 is a partial end view of second embodiment of the dispenser and roll of bags according to the present invention showing hidden detail,

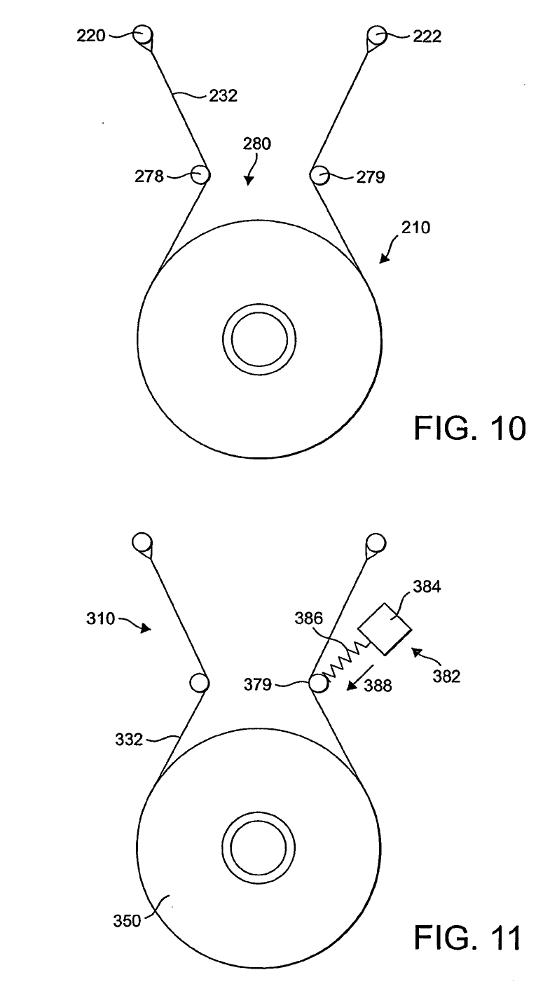

FIG. 9 is a side partial view of the dispenser and roll of bags of FIG. 10 showing hidden detail,

FIG. 10 is a partial end view of third embodiment of the dispenser and roll of bags according to the present invention showing hidden detail,

FIG. 11 is a partial end view of fourth embodiment of the dispenser and roll of bags according to the present invention showing hidden detail.

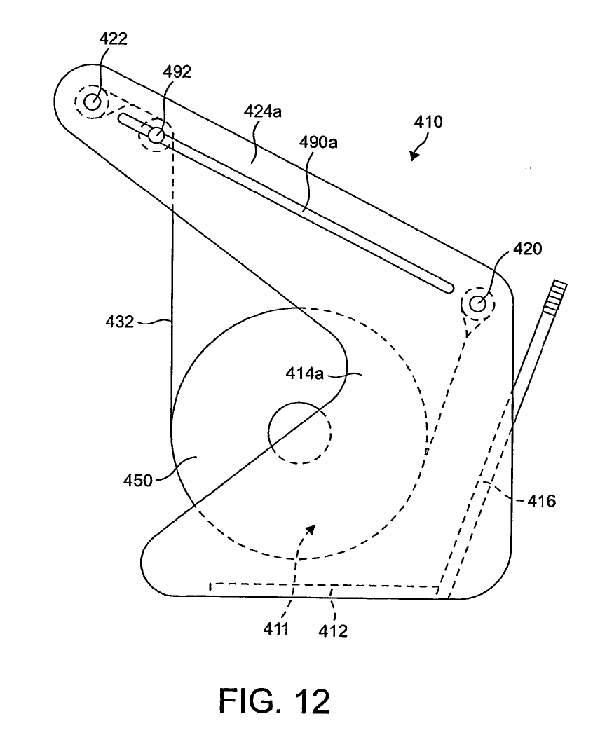

FIG. 12 is a side view of a fifth embodiment of the dispenser and roll of bags according to the present invention, showing hidden detail with the roll of bags in an undepleted state,

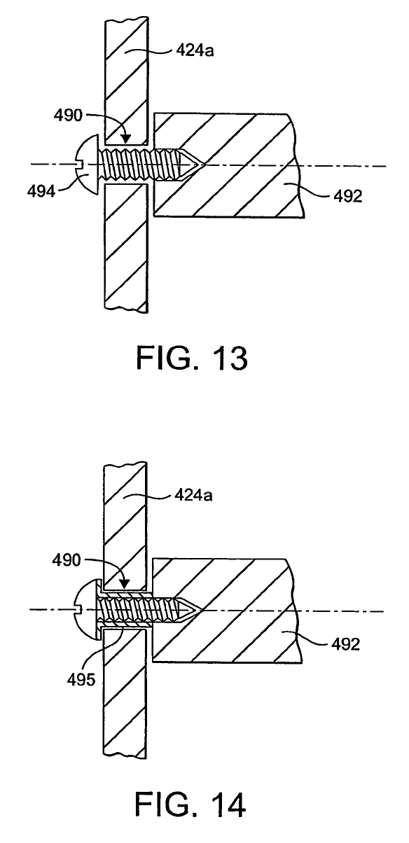

FIG. 13 is an enlarged cross-sectional view of a support arm of the dispenser of FIG. 12,

FIG. 14 is an enlarged cross-sectional view of an alternative embodiment of the support arm shown in FIG. 13,

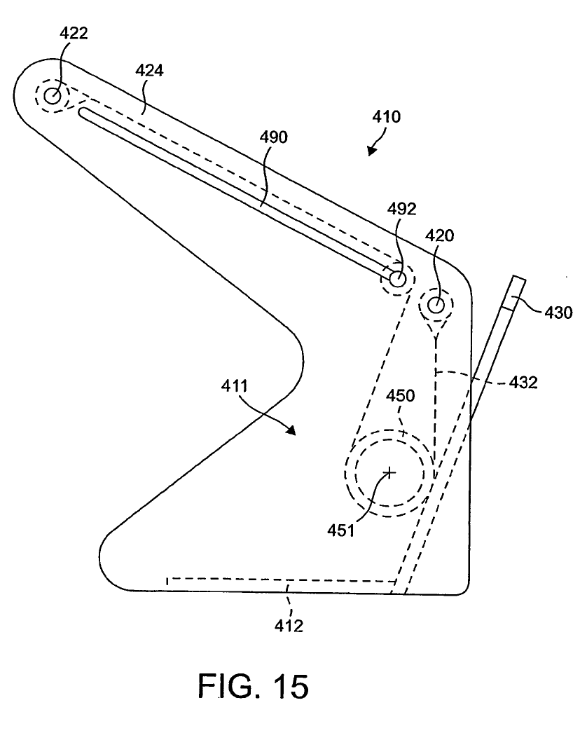

FIG. 15 is a side view of the dispenser roll of bags of FIG. 12 with the roll of bags in a depleted state and showing hidden detail,

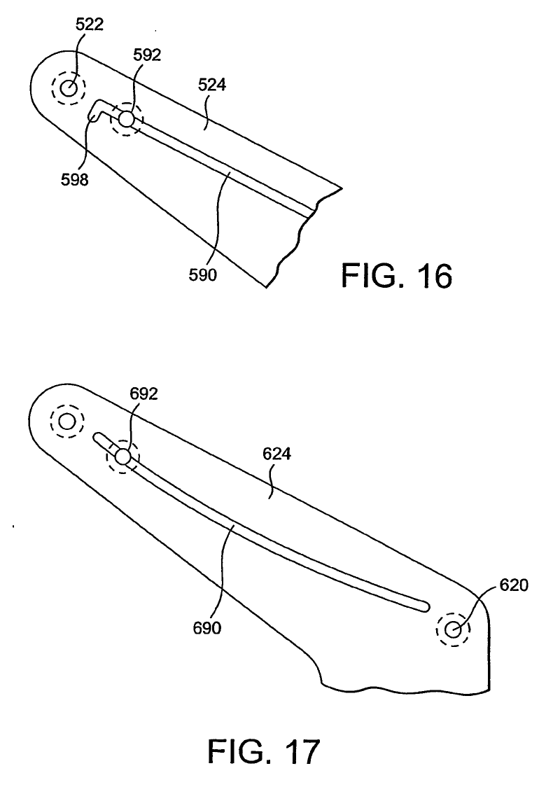

FIG. 16 is a side view of an alternative embodiment of the support arm of the dispenser of FIG. 12,

FIG. 17 is a further alternative embodiment of the support arm of FIG. 12,

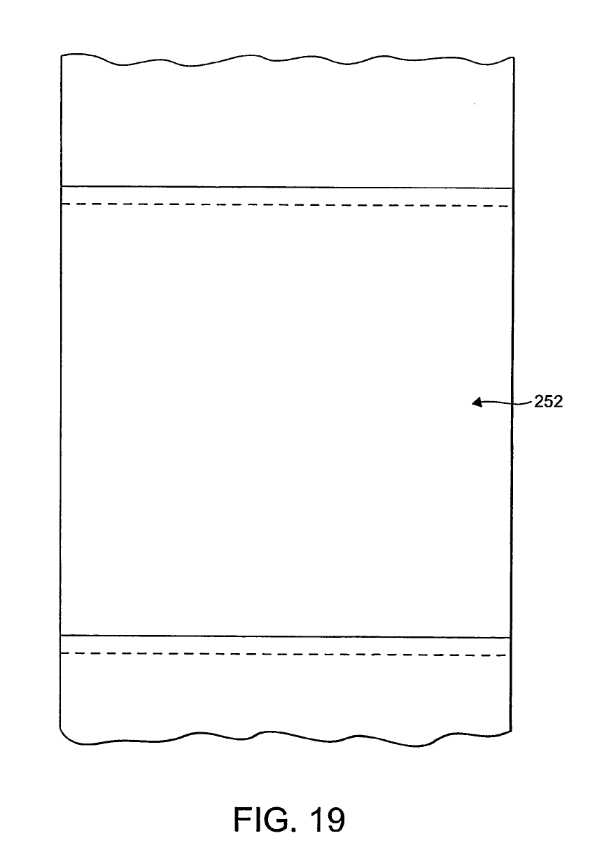

FIG. 19 is a plan view of a bag forming part of a second embodiment of a roll of bags according to the present invention, and

FIG. 19 is a plan view of a bag forming part of a third embodiment of a roll of bags according to the present invention.

FIGS. 1 and 2 show a bag dispenser 10 including a dispenser body 11 and roll of bags 50. The body 11 has a base 12 and two side walls 14a and 14b. A separator plate 16 is arranged to the front of the dispenser and a cross-brace 18 is arranged to the rear. The base 12, separator plate 16 and cross brace 18 separate the side walls 14a, 14b by a distance X.

The walls 14a, b each comprise a lower part 19 to which opposite ends of the base 12 are attached. The walls 14a, b also each have a protruding support arm 24a, b extending from an upper side of the lower part 19. The cross brace 18 extends between the side walls 14a, 14b between the free ends of arms 24a, b.

A first support member 20 is arranged between the side walls 14a, b towards the front of the side walls 14a, 14b at the transition between the lower part 19 and the support arms 24a, b as shown in FIG. 1. A second support member 22 is arranged between the side walls 14a, b to the rear of the dispenser at a point on the support arms 24a, b just inbound of the cross brace 18.

The first and second support members 20, 22 are horizontally spaced apart through a distance Y, and vertically spaced apart through a distance Z. The first support member 20 is vertically displaced from the base 12 by a distance A.

The separator plate 16 is arranged at an angle ∝ to the vertical and defines a substantially rectangular lower portion 26 and a tapered upper portion 28 which forms a separator 30. The separator 30 is in substantially the same horizontal plane as, and in proximity to the first support member 20, although the tip of the separator 30 protrudes slightly above the first support member 20.

Suspended between the first and second support members 20, 22 is a sling 32. The sling 32 has a width substantially the same as the width X between the side walls 14a, 14b. A loop 34 is formed at a first end 36 of the sling 32 for receiving the first support member 20. Likewise, a loop 34 is formed at a second end 38 of the sling 32 for receiving the second support member 22.

The sling 32 is formed from a mesh material, and preferably from a plastic-coated fibre glass mesh material. However, in alternative embodiments it is conceivable that the sling be formed from a number of alternative materials, for example a series of articulated solid slats, chain mail or a unitary plastics material or fabric material.

The sling 32 is arranged between the first support member 20 and second support member 22 so as to be capable of supporting a roll of pre-formed bags 50. It will be appreciated that dimensions A, X and Y may be selected so as to receive a roll 50 of any diameter and width.

In FIGS. 8 and 9 part of the body of the dispenser is not shown for clarity and components common with the first embodiment (FIGS. 1 and 2) are renumbered 100 greater. The dispenser 110 has a single support member 190 on which the sling 132 is retained. The sling 132 supports a roll of bags 50. The sling 132 has a slit 176 through which an unrolled end of the roll of bags 50 protrudes. The relative arrangement of the separator 130 (not shown for clarity) and the slit 176 is identical to the relative arrangement of the separator 30 and the first support member 20 of the first embodiment.

In FIGS. 10 and 11 part of the body of the dispenser is not shown for clarity and components common with the first embodiment (FIGS. 1 and 2) are renumbered 200 greater for the third embodiment (FIG. 10) and 300 greater for the fourth embodiment (FIG. 11).

In FIG. 10 the dispenser 210 has first and second support members 220, 222 that are spaced apart in substantially the same horizontal plane. A sling 232 is supported by the support members 220, 222 in a similar manner to that employed in the first embodiment. First and second sling tension members 278, 279 are arranged so as to introduce a neck 280 to the profile of the sling 232. This necking feature further increases the friction generated between the roll of bags and the sling.

A dispenser 310 is shown in FIG. 11 which is similar to dispenser 210 depicted in FIG. 10 but with the addition of the sling tensioner 382. Sling tensioner 382 includes a base 384 fixedly attached to the body of the dispenser 310 (not shown for clarity), on which is mounted a compression spring 386. The other end of spring 386 acts on second sling tension member 279 which is displaceable in substantially the same line of action as the spring 386.

The removal of individual bags from the roll of bags 350 reduces the weight of the roll. As a result the force acting on the spring 386 reduces causing the second sling tension member 379 to displace in direction 388. In this manner contact between the roll of bags 350 and the sling 332 is optimised during the life of the roll of bags thereby maximising the level of friction generated. This displacement of the second sling tension member 379 has the additional benefit of moving the centre of mass of the roll of bags 350 towards the separator (not shown for clarity), further increasing the level of friction generated between the roll 350 and the sling 332. It will be noted that the spring may be replaced with a suitable elastomeric body or other resilient body.

In an alternative embodiment (not shown), the first and second sling tensioners may be replaced with a resilient loop, for example a rubber band, which extends around the outside of the sling so as to effect the above described necking.

It will be appreciated that in alternative embodiments one or, where appropriate, both of the support members may have an associated sling tensioner. Likewise the support members may be fixed and one, two, or more sling tension members, each with an associated sling tensioner, may be employed.

Furthermore, any of the embodiments described herein may include a sling with a slit for delivery of a bag from the roll of bags. Although the sling is described in the above embodiment as comprising a web of mesh material, it will be appreciated that other ways of effecting a sling will be used. For example, a plurality of rigid slats or rods could be linked together so as to provide the necessary flexibility, or a web of fabric or other flexible material could be used.

FIG. 12 shows a further embodiment of roll dispenser indicated generally at 410 which has a dispenser body 411 and a roll of bags 450 from which no bags have yet been removed, i.e. the roll is in an undepleted state. The body 411 comprises a base 412, a separator plate 416 and side walls 414a, 414b (414a only is shown in FIG. 12) which are arranged in a similar manner to the previous embodiments of bag dispenser. The side walls 414a, 414b include a lower part 419a, 419b and a protruding support arm 424a, 424b. The support arms 424a, 424b retain a first support member 420 and a second support member 422. A sling 432 is suspended about the first and second support members 420, 422 in a manner similar to previous embodiments.

In distinction from the previous embodiments, the support arms 424a, 424b each define a slot 490a, 490b respectively. Each of the slots 490 has a first end proximate the first support member 420 and a second end proximate the second support member 422. The slots 490a, 490b are arranged to slidably retain a moveable support member 492. With reference briefly to FIG. 13, each end of the moveable support member 492 is slidably retained in the slots 490 by way of a retention member in the form of a mushroom-headed screw 494. An alternative method of retaining the moveable support member 492 is shown in FIG. 14, in which the mushroom-headed screw 494 carries a low friction sleeve 494 which runs against the inner surface of the slots 490.

It will be appreciated that other forms of retention member may be used in place of the mushroom-headed screw, such as a rivet, a stud or a screw having a head profile other than a mushroom-head. It is further conceivable that the retention member be defined by a snap-fit plastic pin which could be pushed through the slots 490 to hold the movable support member 492 slideably within the slot 490.

In use, the moveable support member 492 moves down the slot 490 under its own weight from a position proximate the second support member 422 to a position proximate the first support member 420 as the diameter of the roll bag decreases. This reduction in diameter is caused by bags being removed from the roll of pre-formed bags.

The weight of the moveable support member 492 is critical to the operation of the invention since it is its weight that causes the movement of the member 492 down the slots 490. If the member 492 were too light it would remain in a position proximate the second retention member 422 and would not deliver the benefits to the user in terms of offering increased resistance to the removal of a bag from the roll of bags.

It will be appreciated that sufficient friction must be generated between the sling 432 and the roll of bags 450 to allow the user to pull and separate a single bag from the roll of bags 450. As the diameter of the roll of bags 450 decreases, so its weight decreases. A combination of the reduction in diameter of the roll of bags 450 and a reduction in weight inevitably reduces the friction generated between the roll of bags 450 and the sling 432. However, this reduction in friction is minimised by the action of the movement of the movable support member 492 down the slot 490 which causes an increased proportion of the circumference of the roll of bags 450 to remain in contact with the sling 432.

With reference now to FIG. 15, the roll of bags 450 is in a depleted state following the removal of most of the bags from the roll. It will be appreciated that in that state the danger of the whole roll of bags 450 being pulled from the sling 432 by the action of attempted removal of a bag by a user is prevented since the distance between the first support member 420 and the movable support member 492 is less than the diameter of the roll of bags. It will further be appreciated that the centre point 451 of the roll of bags 450 has moved forward towards the separator 430. This has the effect of further increasing the resistance to the removal of a bag from the roll, thereby assisting separation of the bag from the roll of bags.

With reference to FIG. 16, an alternative embodiment of side arm 524 has a slot 590 which defines a seat 598 at an end of the slot approximate the second support member 552. The purpose of the seat 598 is to hold the movable support member 592 safely out of the way of the sling whilst a spent roll of bags is replaced with a new roll of bags.

With reference to FIG. 16, a support arm 624 has a slot 690 which has a curved profile. The purpose of the curved profile is to provide smooth movement of the moveable support member 692 down the slot 690 as the diameter of the roll of bags decreases. As the weight of the roll of bags decreases, so the angle at which the moveable support member 692 may be retained in position in the slot 690 decreases. Thus, the slope of the slot 690 is decreased towards the first support member 620.

It is conceivable that other curved profiles may be used in order to generate differing movements of the moveable support member.

Referring now in further detail to the construction of the roll of bags, the roll 50 (one end of which is shown in FIG. 3) is formed from a continuous flat-folded plastics tube 52. The plastics tube 52 is initially gussetted so as to form a star shape 54 having two gusset folds 56, as shown in FIG. 4 in known manner. The tube is then folded so that opposite longitudinal edges of the tube are folded inwardly toward the longitudinal centreline of the tube, thereby forming two longitudinal fold lines parallel with the longitudinal edges of the tube. The longitudinal fold lines are each arranged closer to the respective adjacent longitudinal edge than to the longitudinal centreline. In that way, when each edge is folded inwardly, it does not reach the centreline. That folding arrangement defines a central portion 60 having a 2 ply thickness and two exterior portions 62a and 62b being of 8 ply thickness. It is conceivable within the scope of the invention that the exterior portions could have additional folds such that they may have a thickness greater than 8-ply, for example 16 ply but the central portion 60 will remain 2 ply only.

With reference to FIG. 6, the flat-folded tube has a plurality of transversely arranged base seals 64. In proximity to the base seal 64, and substantially parallel to it, are perforations 66 in the exterior portions 62a and 62b. Substantially collinear with the perforations 66 is a central slit 68 formed through the central portion 60.

In such a manner the flat folded tube 52 forms a series of individual bags 70. By tearing the perforations 66, and slit 68, a bag 70 is removed from the roll of bags 50. The base seal 64 acts as a base 72 to the bag, and the perforations 66, 68 define a mouth 74 to the bag 70, as shown in FIG. 7.

In use, bag 70 is dispensed in the following manner. The user pulls the bag over the separator 30, gripping the bag at the mouth 74. The roll of bags 50 is caused to rotate in the sling 32. The bag 70 will continue to slide, under the action of the user, over the separator 30 until such time as the separator 30 comes into contact with the central slit 68, at which point the separator 30 will penetrate the slit 68 retarding the progress of the 2 ply central portion. With continued manual pulling by the user, the outermost edges of the multiple ply exterior portions 62 will continue in the direction of pulling, causing the mouth 74 of the bag to begin to open as the gussets and folds of the formed bag begin to unravel. The perforations break, in sequence, around the edges of the folded starting from the centre of the lower face 73 (see FIG. 3). Once enough of the perforations have been broken the strength of the remaining perforations is not sufficient to resist the bag from being detached in its entirety from the next bag. As a result the bag becomes singularly detached from the roll of bags.

It will be appreciated that the friction generated between the sling 32 and the roll of bags 50 causes the bag 70 which is being removed by the user to be pulled taut over the separator 30. This mechanism ensures penetration of the central slit 68 by the separator 30. This in turn improves the repeatability of removal of a bag 70 from the roll of bags 50.

However, even where the separator 30 does not penetrate the central slit 68 the friction generated between the separator 30 and the bag being removed is sufficient to cause the slit 68 and perforations 66 to tear. Furthermore, under this action the bag is still delivered part-opened since the separator acts on the lower face 73 of the bag whilst the upper face 75 is pulled by the user causing the mouth of the bag to open.

Furthermore, the arrangement of the second support member 22 vertically above the first support member 20 ensures that as the roll of bags 50 depletes in size, the angle β (FIG. 2) remains substantially constant so as to ensure a sufficient level of friction is generated between the sling 32 and the roll of bags 50.

It is conceivable within the scope of the invention that the dispenser is capable of dispensing a roll of bags of alternative formation.

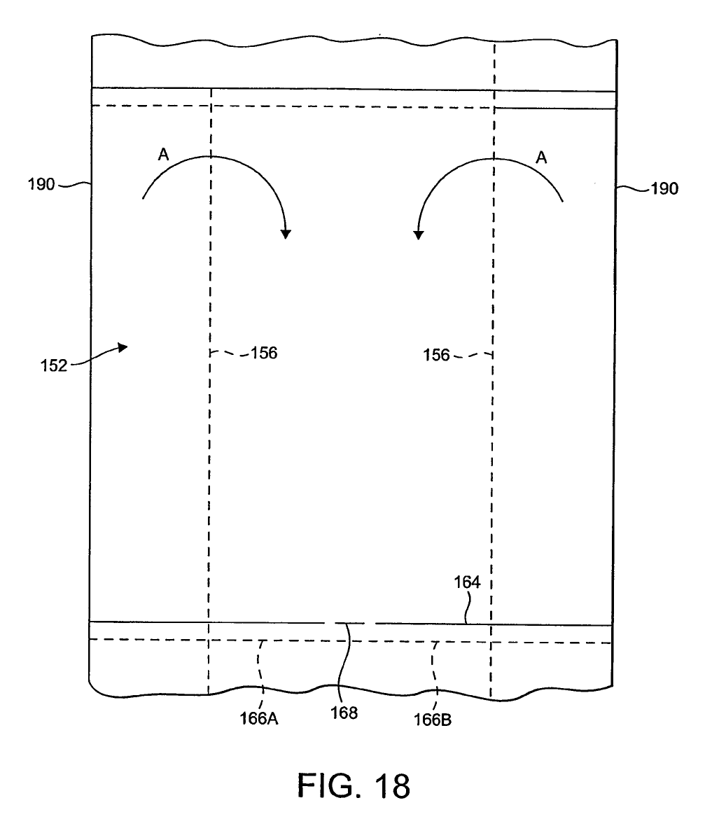

For example, an alternative form of bag, which is dispensed in substantially the same manner as that described above, is formed as follows. Referring to FIG. 18, a roll of bags 150 (shown part way through manufacture in FIG. 18) is formed from a continuous flat-folded plastics tube 152. The plastics tube 152 is initially gussetted so as to form a star shape having two gusset folds 156 in a known manner. In distinction from the first embodiment of roll of bags, a plurality of transversely arranged base seals 164 is applied to the gusseted tube 152 before the subsequent folding process. Likewise, perforations in the exterior portions 166A, 166B and a central slit 168 are also applied to the tube before folding. The tube is then folded so that opposite longitudinal edges 190 of the tube are folded inwardly toward the longitudinal centreline of the tube (the folds indicated by arrow A in FIG. 18) thereby forming two longitudinal fold lines parallel with the longitudinal edges of the tube. This produces a bag with identical dimensions in the rolled state to the previous embodiment, but which opens to form a larger gusset.

A further embodiment of a roll of bags is shown in FIG. 19, in which the roll is formed from a continuous flat-folded plastics tube 252. In distinction from the two previous embodiments of roll of bags the unfolded tube 252 is sealed and perforated before any folding of the tube occurs. This process forms a bag that upon removal from the roll is not gussetted. The exterior portions of the tube 252 may receive one fold on each side to form 4-ply exterior portions or may additionally receive a second fold on each side to form an 8-ply exterior portion similar to previous embodiments of roll of bags only without the gussetted sides.

1. A bag dispenser having a sling for supporting a roll of pre-formed bags.

2. The dispenser according to claim 1 wherein the sling is retained at a first end by a first retention member and at a second end by a second retention member at a second end, the first and second retention members being in fixed relation.

3. The dispenser according to claim 2 wherein the dispenser further comprises a base portion which carries first and second support arms, the first and second retention members being fixed at respective first and second ends of the support arms.

4. The dispenser according to claim 1, wherein the second retention member is arranged such that in use it is vertically above and horizontally displaced from the first retention member.

5. The dispenser according to claim 2, wherein the sling has a length of between 175% and 225% of the distance between the first retention member and the second retention member.

6. The dispenser according to claim 1 wherein the dispenser includes a separator which in use facilitates the separation of a bag from the roll of pre-formed bags.

7. The dispenser according to claim 39 wherein the separator has a tip arranged in proximity to and substantially in the same horizontal plane as the first retention member.

8. The dispenser according to claim 6 wherein the separator is arranged in line with a midpoint of the first retention member.

9. The dispenser according to claim 7 wherein the first member is arranged between the separator and the second retention member.

10. The dispenser according to claim 1 in which the sling is formed from a mesh material, preferably a plastic-coated fibreglass mesh material.

11. The dispenser according to claim 6 in which the tip is coated in a high friction material, preferably a plastic-coated fibreglass mesh material.

12. The dispenser according to claim 2 wherein the sling is supported by a support member.

13. The dispenser according to claim 12 wherein the support member is movable with respect to the first and second retention members.

14. The dispenser according to claim 12 wherein the support member is arranged between the first and second retention members.

15. The dispenser according claim 12 wherein the support member is slidable between a position proximate the second retention member and a position proximate the first retention member.

16. The dispenser according to claim 15 above the support member is slidable along a substantially linear path.

17. The dispenser according to claim 15 wherein the support member is slidable along a curved path.

18. The dispenser according to claim 17 wherein the curved path tends towards the vertical proximate the second retention member and towards the horizontal proximate the first retention member.

19. The dispenser according to claim 15 wherein the dispenser further comprises a base portion which carries first and second support arms the first and second retention members being fixed at respective first and second ends of the support arms and each of the first and second support arms defines a slot for slidably receiving respective first and second ends of the support member.

20. The dispenser according to claim 19 wherein the first and second ends of the support member include a low friction bush slidable within the slots.

21. The dispenser of claim 19 wherein at least one slot has a notch proximate the second retention member in which the support member can be releasably held in a load position to ease loading of a roll of preformed bags into the sling.

22. The dispenser according to claim 12 wherein the support member has a weight of at least 0.25 kg.

23. The dispenser according to claim 12 wherein the support member is of circular cross-section having a diameter of at least 10 mm.

24. The dispenser according to claim 12 wherein the support member includes handles at each end thereof to facilitate movement of the member by a user.

25. A roll of pre-formed bags, the roll being formed from a flat-folded tube, each pre-formed bag having a longitudinally arranged central portion and two longitudinally arranged exterior portions on either side of the central portion, the central portion being of a two-ply cross-section and each of the exterior portions being of an at least eight-ply cross-section.

26. The roll of pre-formed bags as defined in claim 25 wherein the flat-folded tube is gussetted.

27. A roll of pre-formed bags, the roll being_formed from a tube sealed transversely at intervals along its length to form individual bags, each bag having a base end, a mouth end and non-gussetted sides, each bag having a longitudinally arranged, two-ply, central portion and two longitudinally arranged, four-ply exterior portions, one on either side of the central portion, the four-ply exterior portions each being formed by folding the respective side edge of the bag inwardly of the bag after sealing the base end.

28. The roll of pre-formed bags as defined in claim 27 wherein the four-ply exterior portions are folded twice to form an 8-ply cross-section.

29. The roll of pre-formed bags as defined in claim 25 wherein the central portion defines a transversely arranged central slit, each of the exterior portions defining a transversely arranged perforation which is substantially in line with the central slit.

30. The roll of pre-formed bags as defined in claim 25 wherein the pre-formed bag has a base seal arranged in close proximity with the central slit.

31. The roll of pre-formed bags as defined in claim 30 wherein the base seal runs substantially parallel to the central slit and transverse perforations.

32. The roll of pre-formed bags as defined in claim 25 wherein the roll of pre-formed bags includes a cylindrical core of substantially the same width as the pre-formed bag.

33. A method of making a roll of bags including the steps of
forming a continuous tube from a plastics material,
folding the tube so as to form two longitudinally arranged gusset portions,
folding each gusset portion so as to form a longitudinally arranged central portion and two longitudinally arranged exterior portions, one arranged on either side of the central portion, the central portion being of two ply cross-section and each of the exterior portions being of an at least_{—}8 ply cross-section,
further including the steps of transversely sealing the continuous tube at a predetermined interval so as to form a base seal,
transversely perforating the exterior portions in close proximity to the base seal,
forming a slit in the central portion which is substantially in line with the perforations rolling the continuous tube into a roll of bags.

34. A method of making a roll of bags including the steps of forming a continuous tube from a plastics material, the tube having a central portion and two longitudinally arranged exterior portions, one arranged on either side of the central portion, transversely sealing the continuous tube at a predetermined interval so as to form a base seal, transversely perforating the exterior portions in close proximity to the base seal, forming a slit in the central portion which is substantially in line with the perforations, folding the tube so that the central portion is of two ply cross-section and each of the exterior portions are of at least 4 ply cross-section, further including the step of rolling the continuous tube into a roll of bags.

35. The method of claim 34 in which the step of folding the tube comprises folding the tube so that the exterior portions are of 4-ply cross-section then refolding the exterior portions again so as to form an 8-ply cross-section.

36. A method of separating a bag from the roll of bags of claim 25 where the roll of bags is held within a bag dispenser having a sling for supporting a roll of pre-formed bags, the dispenser including a separator which in use facilitates the separation of a bag from the roll of pre-formed bags, the method including the steps of:
pulling the bag over the separator so as to inhibit movement of the lower ply of the central portion relative to the upper ply, thereby opening the mouth of the bag.

37. The method of claim 36 further including the step of pulling the bag further over the separator so that the friction generated between the separator and the bag allows continued pulling to cause the bag to separate from the roll of bags.

38. The method of claim 36 further including the step of pulling the bag further over the separator so that the separator penetrates the central slit, allowing continued pulling of the bag to separate the bag from the roll of bags.

39. The dispenser according to claim 2, wherein the dispenser includes a separator which in use facilitates the separation of a bag from the roll of pre-formed bags.
